(19) United States
(12) Patent Application Publication
(10) Pub. No.: US 2012/0234929 A1
(43) Pub. Date: Sep. 20, 2012

(54) WATER HEATER WITH FEEDBACK CONTROL SYSTEM

(75) Inventors: Chung-Chin Huang, Taichung (TW); Chin-Ying Huang, Taichung (TW); Hsin-Ming Huang, Taichung (TW); Hsing-Hsiung Huang, Taichung (TW)

(73) Assignee: GRAND MATE CO., LTD., Taichung (TW)

(21) Appl. No.: 13/048,209

(22) Filed: Mar. 15, 2011

(51) Int. Cl. G05D 23/00; F24H 1/00

(52) U.S. Cl. 236/51; 126/344

(57) ABSTRACT

A water heater includes a remote controller having a setting unit and a display unit; an electronic heater having a circuit board, a combustor, and a sensing unit, wherein the sensing unit reads the electronic heater; and an exchanger having a first transmitter, a first receiver, and a first converter electrically connected to the remote controller, and a second transmitter, a second receiver, and a second converter electrically connected to the electronic heater. The first transmitter transmits a signal from the setting unit to the circuit board through the second receiver, to control the electronic heater according to the signal, and the second transmitter transmits signal from the sensing unit to the first receiver of the remote controller, to show real-time information of the electronic heater on the display unit.

### BACKGROUND OF THE INVENTION

1. Field of the Invention

The present invention relates generally to a gas stove, and more particularly, to a water heater equipped with a feedback control system.

2. Description of the Related Art

A conventional electronic water heater, which burns gas, controls the ignition and air blower, and sets water temperature, gas flow and flame by an electronic control system. The electronic control system may perform its precise control task to maximize the efficiency of the water heater. The control panel of the electronic control system is provided on the case of the water heater, and the water heater usually is installed outdoors for safety. For example, when one needs to change the water temperature, he/she has to go outside to operate the water heater, and that can be very inconvenient.

To overcome such inconvenience, people in the industry have developed a remote control system that makes controlling the water heater from home possible. This system includes a remote controller that can either be wired to the water heater, or, wirelessly connected to the water heater. Such remote control system can only transmit a single message from the remote controller to the water heater, in which user has no choice but blindly controls the water heater without any information about the water heater, and that may lead to some safety issues. For example, when one operates the remote controller to adjust the water temperature, gas flow or flame, he/she cannot actually comprehend the real condition of operation of the water heater, such as whether or not the water temperature arrives at the desired temperature, or if the flame is switched on to the desired intensity, whether the water heater is still burning, and if the air blower is working properly. The user receives none of these information about the water heater. This can cause accidents to happen, when the water heater malfunctions, but the user has no idea, and is still remote controlling it.

### SUMMARY OF THE INVENTION

The primary objective of the present invention is to provide a water heater equipped with a feedback control system, which transmits signals in both ways to report user the present condition of the water heater for safety.

To meet the primary objective, the present invention provides a water heater with a feedback control system, including a remote controller having a setting unit and a display unit; an electronic heater having a circuit board, a combustor, and a sensing unit, wherein the sensing unit reads the electronic heater; and an exchanger having a first transmitter, a first receiver, and a first converter electrically connected to the remote controller, and a second transmitter, a second receiver, and a second converter electrically connected to the electronic heater. The first transmitter transmits a signal from the setting unit to the circuit board through the second receiver, to control the electronic heater according to the signal, and the second transmitter transmits signal from the sensing unit to the first receiver of the remote controller, to show real-time information of the electronic heater on the display unit.

### BRIEF DESCRIPTION OF THE DRAWINGS

FIG. 1 is a front view of the water heater of a preferred embodiment of the present invention;

FIG. 2 is a left view of the water heater of the preferred embodiment of the present invention;

FIG. 3 is a block diagram, showing the signal transmission of the preferred embodiment of the present invention;

FIG. 4 is a front view of the remote controller of the preferred embodiment of the present invention;

FIG. 5 is a flow chart of the signal transmission from the remote controller to the water heater; and

FIG. 6 is a flow chart of the signal transmission from the water heater to the remote controller.

### DETAILED DESCRIPTION OF THE INVENTION

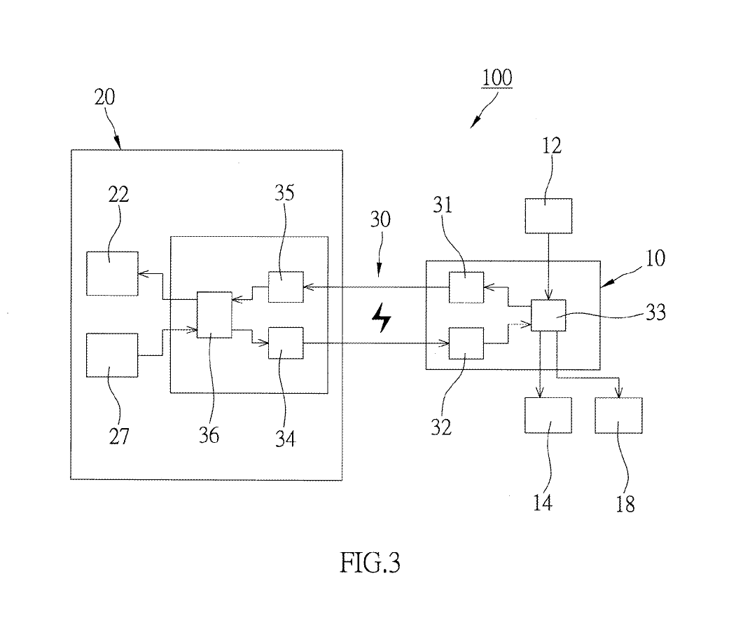

As shown in FIG. 1 to FIG. 3, a water heater 100 of the preferred embodiment of the present invention includes a remote controller 10, an electronic heater 20, and an exchanger 30.

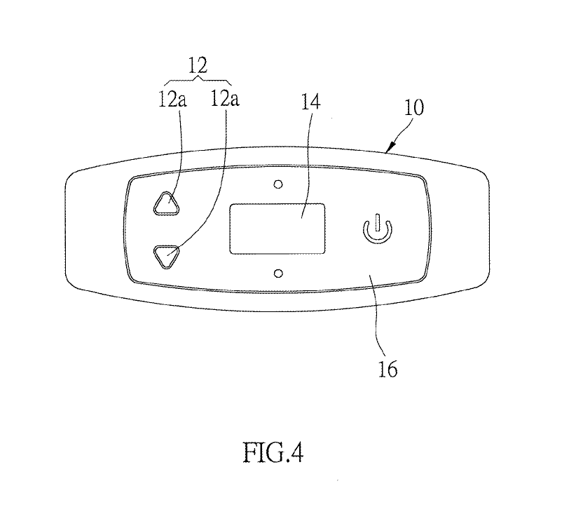

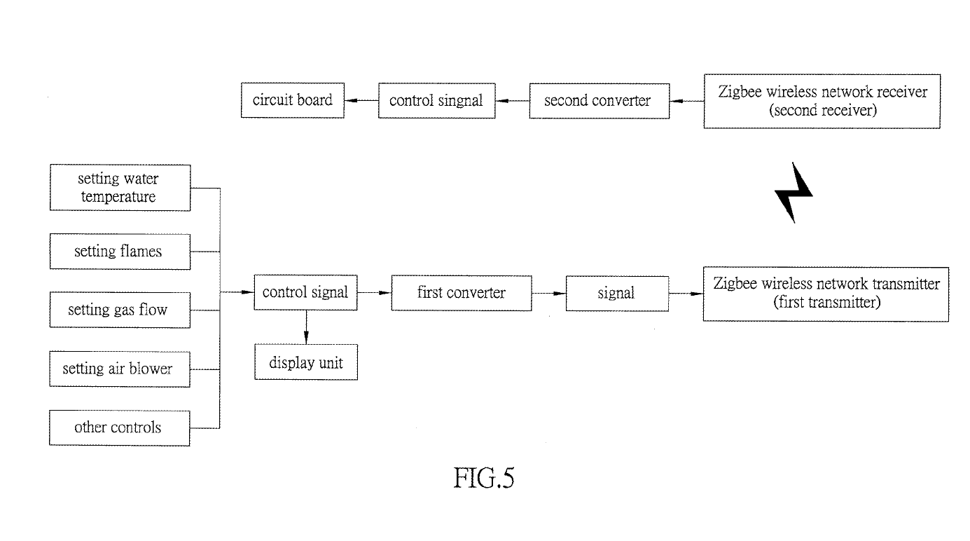

The remote controller 10 is mounted inside a house or building, such as in the bathroom. As shown in FIG. 4, the remote controller 10 includes a setting unit 12 and a display unit 14. The setting unit has a panel 16 with a plurality of keys 12a for various controls. Each key 12a generates a signal when the key 12a is pressed. The display unit 14 is a screen on the panel 16 of the remote controller 10.

The electronic heater 20 is mounted outdoors and includes a case 21, a circuit board 22, and an air blower 23, a plurality of burners 24, a water pipe 25, a gas pipe 26, and a sensing unit 27. The air blower 23, the burners 24, and the gas pipe 26 construct a combustor.

The circuit board 22, the air blower 23, the burners 24 and the water pipe 25 are mounted in the case 21.

The gas pipe 26 is connected to a gas supply (not shown) to provide the burner 24 gas.

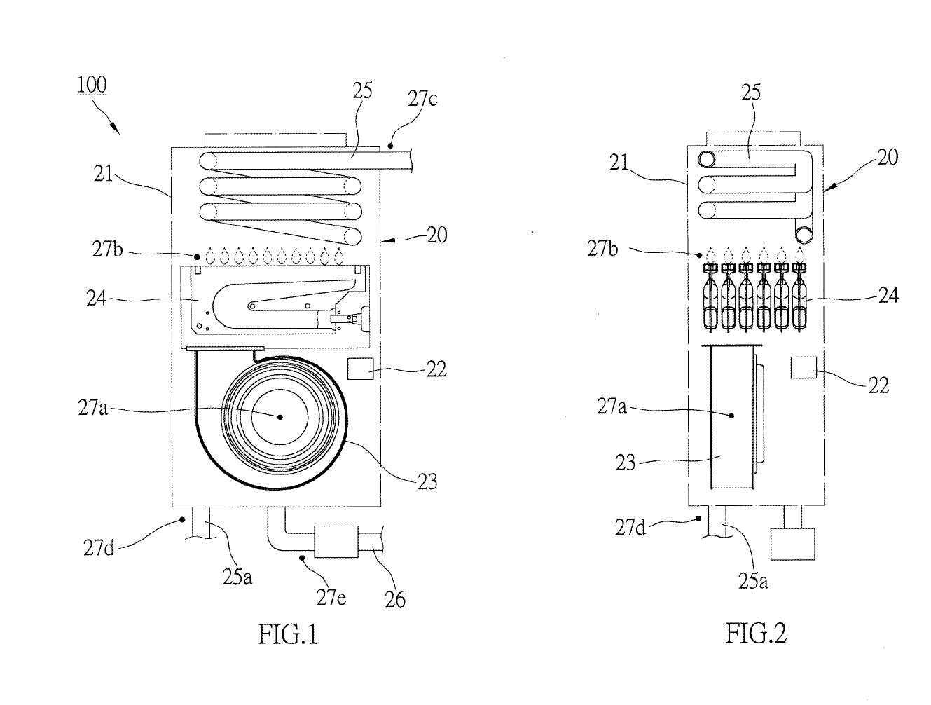

The sensing unit 27 has five sensors 27a˜27e mounted at different places to read different objects. As shown in FIG. 1 and FIG. 2, the sensor 27a reads a speed of the air blower, the sensor 27b reads the burners 27 to make sure they are burning properly, the sensor 27c reads a flow rate in the water pipe 25, the sensor 27d reads a water temperature of water at an outlet 25a of the water pipe 25, and the sensor 27e reads a flow rate and a pressure in the gas pipe 26. The results of the sensors 27a˜27e are combined into a real-time signal. The sensing unit 27 may provide further sensor(s) at suitable place(s) according to the object of sensing.

The exchanger 30 includes a first transmitter 31, a first receiver 32, and a first converter 33 electrically connected to the remote controller 10, and a second transmitter 34, a second receiver 35, and a second converter 36 electrically connected to the electronic heater 20. The communication between the transmitters and the receivers is wireless communication, which has low power consumption, and is low in power, such as ZigBee wireless network transmitter and receiver.

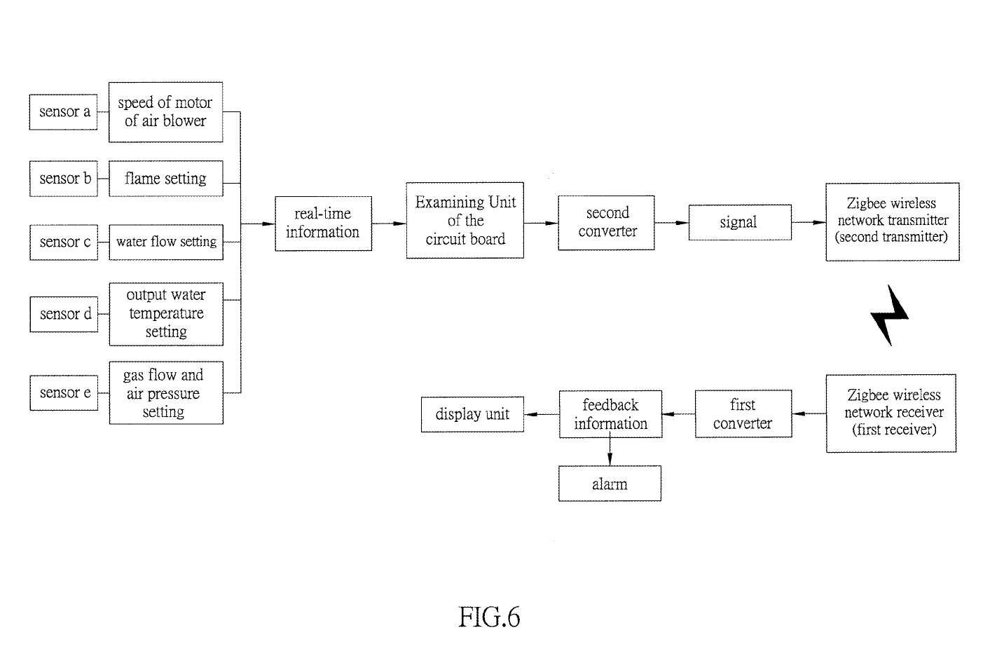

As shown in FIG. 5, the first transmitter 31, the first receiver 32, and the first converter 33 are mounted in the remote controller 10. When a user operates the remote controller 10 and presses one key 12a, the first converter 33 converts the signal from the key 12a, and transmit it to the second receiver 35 in the electronic heater 20, and then the electronic heater 20 transmits the signal to the second converter 36, to convert it into a control signal to control the electronic heater 20 through the circuit board 22 for changing water temperature, setting flames, setting gas flow, and other controls. At the same time, the display unit 14 of the remote controller 10, shows the information about this control, such as setting water temperature.

As shown in FIG. 6, when the electronic heater 20 is at work, the sensors 27a˜27e are reading the predetermined objects of the electronic heater 20, and transmitting signals to the circuit board 22. The circuit board 22 has an examining unit 22a to examine the signals from the sensors 27a˜27e, to find out whether there is any abnormal condition. The signals, including normal signal and abnormal signal, are transmitted to the second converter 36, to convert the signal for transmission. After that, the second transmitter 34 transmits the signal from the second converter 36, to the first receiver 32. Likewise, the first receiver 32 transmits the signal to the second converter 36, for converting the signal to readable data, and showing on the display unit 14 of the remote controller 10 to show the user some real-time information about the electronic heater 20. Such feedback information can make a user understand, whether the electronic heater 20 completes the order (such as whether the water temperature at the outlet 25a arrives at the setting temperature), and detects the electronic heater 20, to find whether any abnormal conditions exist (such as no flame on the burners 24, or if speed of the motor of the air blower 23 is functioning normally). The display unit 14 of the remote controller 10 will show an alarm when an abnormal condition of the electronic heater 20 is detected that user may respond accordingly. The remote controller 10 is further provided with an alarm 18, to provide a buzzing sound or a flash light when an abnormal condition is detected.

The present invention provides a bi-directional signal transmission between the heater and the remote controller that user may operate the heater at home, and get real-time information about the heater. The present invention provides ZigBee wireless transmission for the communication between the heater and the remote controller that a reliable signal transmission can be obtained at a low cost, not to mention it has low power, and it may have a long time of operation because of the low power consumption.

The description above is a few preferred embodiments of the present invention and the equivalence of the present invention is still in the scope of claim construction of the present invention.

What is claimed is:

1. A water heater with a feedback control system, comprising:
a remote controller having a setting unit and a display unit;
an electronic heater having a circuit board, a combustor, and a sensing unit, wherein the sensing unit reads the electronic heater; and
an exchanger having a first transmitter, a first receiver, and a first converter electrically connected to the remote controller, and a second transmitter, a second receiver, and a second converter electrically connected to the electronic heater, wherein the first transmitter transmits a signal from the setting unit to the circuit board through the second receiver, to control the electronic heater according to the signal, and the second transmitter transmits signal from the sensing unit to the first receiver of the remote controller, to show real-time information of the electronic heater on the display unit.

2. The water heater as defined in claim 1, wherein the transmitters of the exchanger are ZigBee wireless network transmitters and the receivers of the exchanger are ZigBee wireless network receivers.

3. The water heater as defined in claim 2, wherein the exchanger further has a first converter in the remote controller to convert the signal from the setting unit, and transmit the signal to the ZigBee wireless network transmitter of the remote controller, and a second converter in the electronic heater, to convert the signals from the sensing unit and transmit the signals to the ZigBee wireless network transmitter of the electronic heater.

4. The water heater as defined in claim 1, wherein the circuit board of the electronic heater has an examining unit to examine the signal from the sensing unit.

5. The water heater as defined in claim 4, further comprising an alarm to provide an alarm signal when the examining unit finds an abnormal signal from the sensing unit.

6. The water heater as defined in claim 5, wherein the combustor of the electronic heater, includes an air blower, a plurality of burners and a gas pipe.
